(19) United States
(12) Patent Application Publication
(10) Pub. No.: US 2021/0064886 A1
(43) Pub. Date: Mar. 4, 2021

(54) INFORMATION PROCESSING DEVICE AND COMPUTER PROGRAM PRODUCT

(71) Applicant: FUJITSU CLIENT COMPUTING LIMITED, Kanagawa (JP)

(72) Inventor: Kei Kato, Kawasaki (JP)

(73) Assignee: FUJITSU CLIENT COMPUTING LIMITED, Kanagawa (JP)

(21) Appl. No.: 16/924,729

(22) Filed: Jul. 9, 2020

(30) Foreign Application Priority Data
Aug. 27, 2019 (JP) 2019-155024
Aug. 27, 2019 (JP) 2019-155032

(51) Int. Cl. G06K 9/00

(52) U.S. Cl. CPC G06K 9/00778; G06K 9/00375; G06K 9/00691; G06K 9/00369

(57) ABSTRACT

An information processing device includes a hardware processor that: acquires image data obtained by imaging the same place for a plurality of times; detects a person from the image data; and generates filter information indicating a movable region in which the person is able to move, based on coordinates indicating a predetermined position in a person region representing the person detected at each time.

### CROSS-REFERENCE TO RELATED APPLICATIONS

This application is based upon and claims the benefit of priority from Japanese Patent Applications No. 2019-155024 and No. 2019-155032, both filed on Aug. 27, 2019, the entire contents of all of which are incorporated herein by reference.

### FIELD

Embodiments described herein relate generally to an information processing device and a computer program product.

### BACKGROUND

Conventionally, widely known are person detection technologies of detecting a person included in an image. The person detection technologies may possibly erroneously detect an article other than a person as a person. To address this, there has been a demand for reducing erroneous detection of an article as a person.

In some cases, it is not necessary to detect a person from all the regions on the image. When the image includes aisles and shelves, for example, it can be considered that a person may be present on the aisles but no person is present on the shelves. In this case, detecting a person from the shelves can be considered to be erroneous detection. As described above, defining a region with no person can reduce erroneous detection of an article as a person (refer to Japanese Patent Application Laid-open No. 2019-121904).

It is, however, difficult to generate filter information defining a region with no person.

In view of the disadvantage described above, an object of the present invention is to generate filter information.

### SUMMARY

An information processing device according to the first aspect of the present invention includes a hardware processor configured to: acquire image data obtained by imaging a same place for a plurality of times; detect a person from the image data; and generate filter information indicating a movable region in which the person is able to move, based on coordinates indicating a predetermined position, in a person region representing the person detected at each time.

A computer program product according to the second aspect of the present invention includes programmed instructions embodied in and stored on a non-transitory computer readable medium. The instructions cause a computer to: acquire image data obtained by imaging a same place for a plurality of times; detect a person from the image data; and generate filter information indicating a movable region in which the person is able to move, based on coordinates indicating a predetermined position, in a person region representing the person detected at each time.

### BRIEF DESCRIPTION OF THE DRAWINGS

FIG. 1 is a diagram illustrating an example of an entire configuration of a distributed computer according to an embodiment of the present invention;

FIG. 2 is a diagram illustrating an example of a hardware configuration of devices in the distributed computer;

FIG. 3 is a diagram for explaining an example of communications between platforms according to the present embodiment;

FIG. 4 is a functional block diagram illustrating an example of a functional configuration of units in the distributed computer according to the present embodiment;

FIG. 5 is a diagram illustrating an example of a result of detecting persons from image data taken by a camera;

FIG. 6 is a diagram illustrating an example of the image data on which an excluded region is set;

FIG. 7 is a diagram illustrating an example of filter information;

FIG. 8 is a functional block diagram illustrating an example of a functional configuration of a person identification processing unit;

FIG. 9 is a functional block diagram illustrating an example of a functional configuration of the platform;

FIG. 10 is a diagram illustrating an example of a result of detecting a person candidate by a person detection unit;

FIG. 11 is a diagram illustrating an example of a detection result depending on the position for imaging the person candidate by the person detection unit;

FIG. 12 is a diagram illustrating an example of plotting a coordinate point;

FIGS. 13A to 13D are diagrams illustrating an example of a plot position of the coordinate point;

FIG. 14 is a diagram illustrating an example of a state where the coordinate points are connected in time-series order;

FIG. 15 is a flowchart illustrating an example of filter generation according to the present embodiment; and

FIG. 16 is a flowchart illustrating person identification by the person identification processing unit according to the present embodiment.

### DETAILED DESCRIPTION

Exemplary embodiments of an information processing device and a computer program according to the present invention are described below in greater detail with reference to the accompanying drawings. The embodiments are not intended to limit the invention.

### First Embodiment

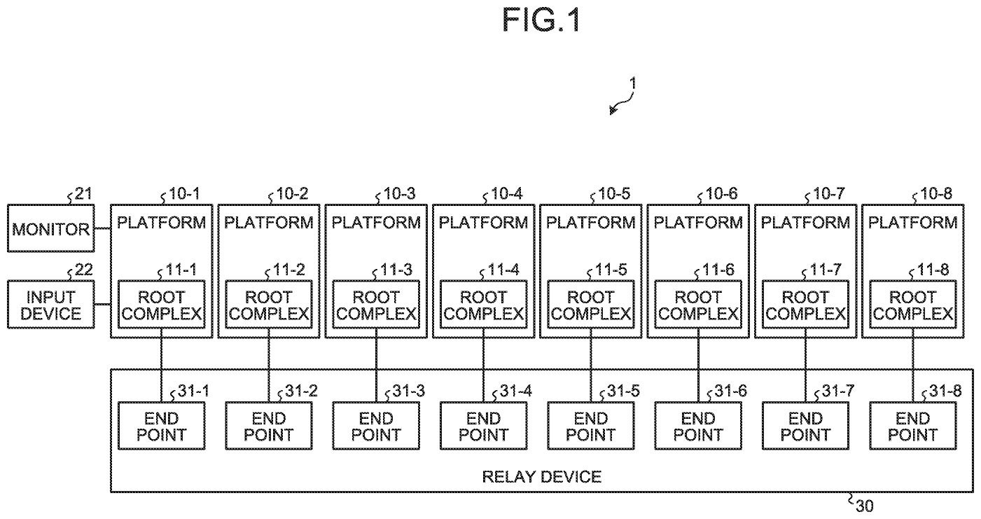

FIG. 1 is a diagram illustrating an example of the entire configuration of a distributed computer 1 according to an embodiment of the present invention. The distributed computer 1 is an information processing system including a plurality of platforms 10-1 to 10-8 and a relay device 30 that communicably connects the platforms 10-1 to 10-8. As illustrated in FIG. 1, the distributed computer 1 according to the embodiment includes the platforms 10-1 to 10-8 and the relay device 30.

The platforms 10-1 to 10-8 are communicably connected via the relay device 30. The platforms 10-1 to 10-8 are inserted into slots on a board provided with the relay device 30, for example. Any of the slots may be vacant with none of the platforms 10-1 to 10-8 inserted thereinto. In the following description, a certain platform out of the platforms 10-1 to 10-8 is referred to as a platform 10 when the platforms 10-1 to 10-8 need not be distinguished.

The platform 10-1 is a main information processing device that manages and causes the platforms 10-2 to 10-8 to perform various kinds of processing.

The platform 10-1 is connected to a monitor 21 and an input device 22. The monitor 21 displays various screens of a liquid crystal display device, for example. The input device 22 receives various operations performed on a keyboard or a mouse, for example.

The platforms 10-2 to 10-8 are sub-information processing devices that perform artificial intelligence (AI) inference and image processing, for example, based on a request from the platform 10-1. The platforms 10-2 to 10-8 may have respective different functions, or a plurality of platforms 10 may have the same function.

The platforms 10-1 to 10-8 include root complexes (RC) 11-1 to 11-8, respectively, that can operate as a host. In the following description, a certain RC out of the RCs 11-1 to 11-8 is referred to as an RC 11 when the RCs 11-1 to 11-8 need not be distinguished.

The RCs 11 perform communications with respective end points 31-1 to 31-8 of the relay device 30. In other words, the platforms 10 and the relay device 30 are communicably connected by a communication standard, such as peripheral component interconnect express (PCIe). The platforms 10 and the relay device 30 may be connected by a communication standard other than PCIe.

The relay device 30 includes the end points (EP) 31-1 to 31-8. The relay device 30 relays communications between the platforms 10 including the RCs 11 connected to the respective EPs 31-1 to 31-8.

The EPs 31-1 to 31-8 perform communications with the RCs 11 of the respective platforms 10. In the following description, a certain EP out of the EPs 31-1 to 31-8 is referred to as an EP 31 when the EPs 31-1 to 31-8 need not be distinguished.

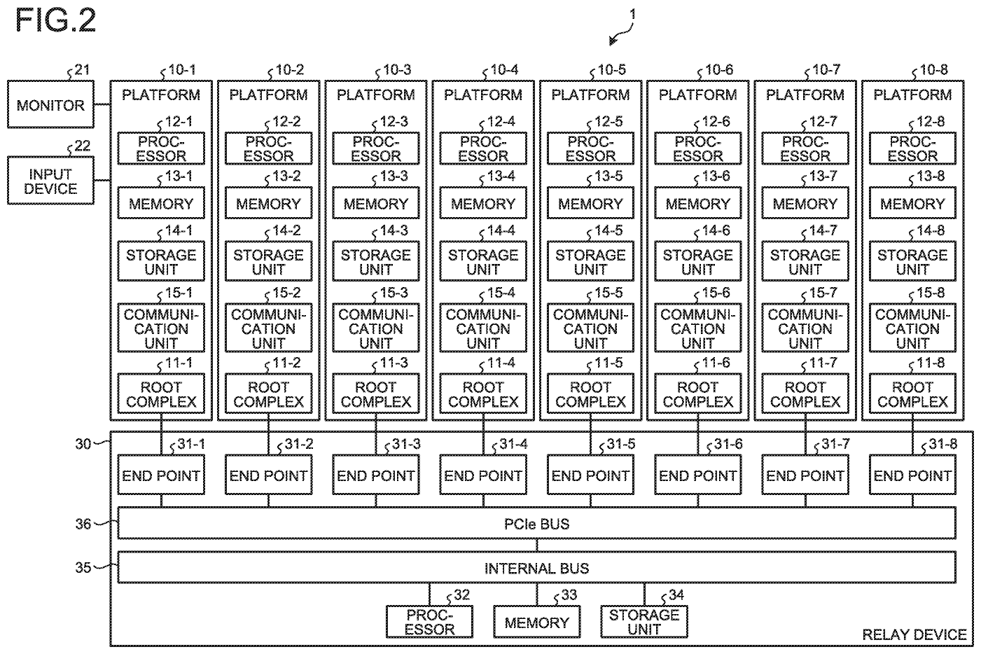

The following describes a hardware configuration of devices of the distributed computer 1. FIG. 2 is a diagram illustrating an example of the hardware configuration of the devices in the distributed computer 1. While the following describes the hardware configuration of the platform 10-1 as an example, the platforms 10-2 to 10-8 have the same configuration.

The platform 10-1 is a computer that performs arithmetic processing, such as AI processing and image processing. The platform 10-1 includes the RC 11-1, a processor 12-1, a memory 13-1, a storage unit 14-1, and a communication unit 15-1. These units are communicably connected via a bus.

The processor 12-1 collectively controls the platform 10-1. The processor 12-1 may be a multiprocessor. The processor 12-1 may be any one of a central processing unit (CPU), a micro processing unit (MPU), a graphics processing unit (GPU), a digital signal processor (DSP), an application specific integrated circuit (ASIC), a programmable logic device (PLD), and a field programmable gate array (FPGA), for example. The processor 12 may be a combination of two or more kinds of elements out of CPU, MPU, GPU, DSP, ASIC, PLD, and FPGA. In the following description, a certain processor out of the processors 12-1 to 12-8 is referred to as a processor 12 when the processors 12-1 to 12-8 need not be distinguished.

The memory 13-1 is a storage memory including a read only memory (ROM) and a random access memory (RAM). In the ROM of the memory 13-1, various software programs and kinds of data for the programs are written. The software program on the memory 13-1 is appropriately read and executed by the processor 12. The RAM of the memory 13-1 is used as a primary storage memory or a working memory. In the following description, a certain memory out of the memories 13-1 to 13-8 is referred to as a memory 13 when the memories 13-1 to 13-8 need not be distinguished.

The storage unit 14-1 is a storage device, such as a hard disk drive (HDD), a solid state drive (SSD), and a storage class memory (SCM), and stores therein various kinds of data. The storage unit 14-1, for example, stores therein various software programs. In the following description, a certain storage unit out of the storage units 14-1 to 14-8 is referred to as a storage unit 14 when the storage units 14-1 to 14-8 need not be distinguished.

The platform 10 implements various functions by the processor 12 executing the software programs stored in the memory 13 and the storage unit 14.

The various software programs are not necessarily stored in the memory 13 and the storage unit 14. The software programs may be stored in a storage medium readable by a medium reading device, for example, and read and executed by the platform 10. Examples of the storage medium readable by the platform 10 include, but are not limited to, a portable storage medium including a CD-ROM, a DVD disc, and a universal serial bus (USB) memory, a semiconductor memory including a flash memory, a hard disk drive, etc. Furthermore, the software programs may be stored in a device connected to a public network, the Internet, a LAN, or the like and read and executed by the platform 10.

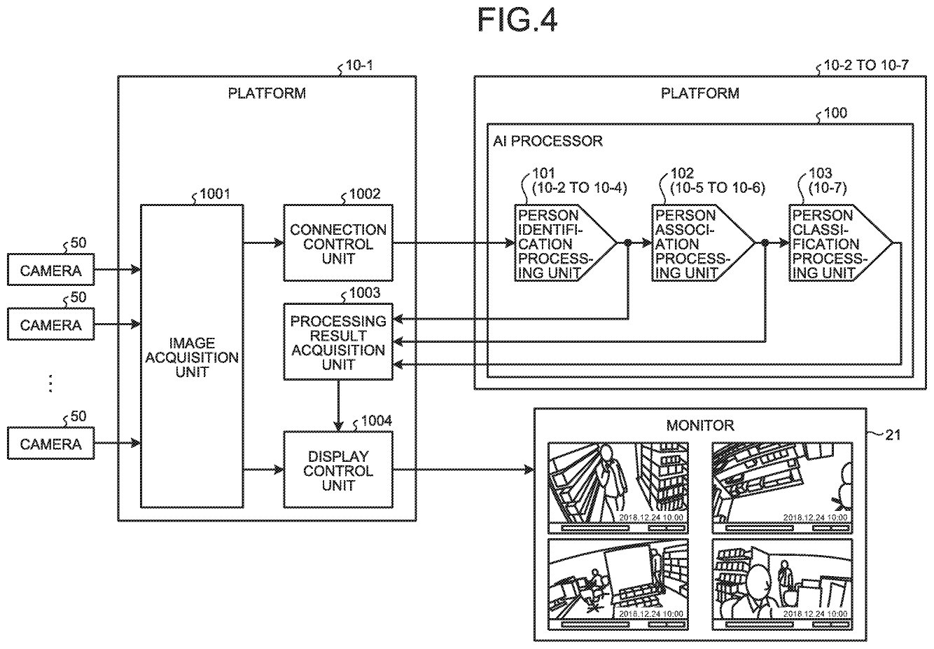

The communication unit 15-1 is an interface for establishing connection with cameras 50 (refer to FIG. 4) wiredly or wirelessly. In the following description, a certain communication unit out of the communication units 15-1 to 15-8 is referred to as a communication unit 15 when the communication units 15-1 to 15-8 need not be distinguished.

The following describes the relay device 30. The relay device 30 includes the EPs 31-1 to 31-8 provided for the respective platforms 10, a processor 32, a memory 33, a storage unit 34, an internal bus 35, and a PCIe bus 36. In the following description, a certain EP out of the EPs 31-1 to 31-8 is referred to as an EP 31 when the EPs 31-1 to 31-8 need not be distinguished.

The EPs 31 are provided for the respective platforms 10 and transmit and receive data. When the EP 31 receives data from the platform 10 connected thereto, for example, the EP 31 transmits the received data to the EP 31 connected to the destination platform 10 via the PCIe bus 36.

The RC 11, for example, transmits data to another platform 10 by direct memory access (DMA) transfer. In other words, when the EP 31 receives data from the EP 31 connected to the platform 10 serving as the source of the data via the PCIe bus 36, the EP 31 transmits the received data to the platform 10 connected thereto.

The processor 32 collectively controls the relay device 30. The processor 32 may be a multiprocessor. The processor 32 may be any one of a CPU, an MPU, a GPU, a DSP, an ASIC, a PLD, and an FPGA, for example. The processor 32 may be a combination of two or more kinds of elements out of CPU, MPU, GPU, DSP, ASIC, PLD, and FPGA.

The memory 33 is a storage device including a ROM and a RAM. In the ROM, various software programs and kinds of data for the programs are written. The software programs stored in the memory 33 is read and executed by the processor 32. The RAM is used as a working memory.

The storage unit 34 is a storage device, such as an HDD, an SSD, and an SCM, and stores therein various kinds of data. The storage unit 34, for example, stores therein various software programs.

The internal bus 35 communicably connects the processor 32, the memory 33, the storage unit 34, and the PCIe bus 36.

The PCIe bus 36 communicably connects a plurality of EPs 31 and the internal bus 35. In other words, the PCIe bus 36 connects a plurality of EPs 31 such that they can transfer data therebetween. The PCIe bus 36 conforms to the PCIe standard, for example.

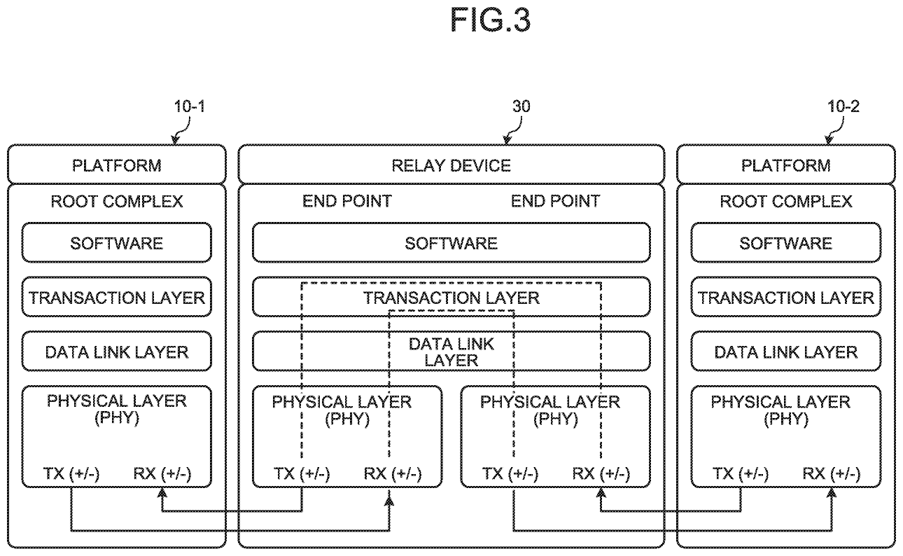

The following describes an example of communications between the platform 10-1 and the platform 10-2 connected to the relay device 30. FIG. 3 is a diagram for explaining an example of communications between the platforms 10 in the distributed computer 1 according to the present embodiment. While the following describes an example of communications between the platform 10-1 and the platform 10-2, the other platforms 10 also perform communications therebetween in the same manner.

As illustrated in FIG. 3, the distributed computer 1 has a layer structure defined by the PCIe standard, for example. The distributed computer 1 performs communications between the platforms 10 via the layers.

The source platform 10-1 transfers data specified by software to a physical layer (PHY) of the relay device 30 via a transaction layer, a data link layer, and a physical layer (PHY).

The relay device 30 transmits the data transferred from the source platform 10-1 to the transaction layer via the physical layer (PHY) and the data link layer. In the transaction layer, the relay device 30 transfers the data to the EP 31 corresponding to the destination platform 10-2 by tunneling. The relay device 30 transfers the data to the physical layer (PHY) of the destination platform 10-2 via the transaction layer, the data link layer, and the physical layer (PHY). As described above, the relay device 30 transfers the data from the source platform 10-1 to the destination platform 10-2 by tunneling the data between the EPs 31.

The destination platform 10-2 transmits the data to software via the physical layer (PHY), the data link layer, and the transaction layer.

When transfer of data is not concentrated on one platform 10 out of the platforms 10 connected to the relay device 30, the relay device 30 can transfer data in parallel between the platforms 10 of different desired combinations.

To perform communications between the platforms 10-2 and 10-3 and the platform 10-1, for example, the relay device 30 performs the communications with the platforms 10-2 and 10-3 by serial processing. By contrast, when different platforms 10 perform communications, and communications are not concentrated on a specific platform 10, the relay device 30 performs the communications between the platforms 10 by parallel processing.

The following describes characteristic functions included in the distributed computer 1 according to the present embodiment.

FIG. 4 is a functional block diagram illustrating an example of a functional configuration of the units in the distributed computer 1 according to the present embodiment. FIG. 4 does not illustrate the relay device 30.

The platform 10-1 is described first.

The processor 12-1 of the platform 10-1 is a computer that implements the functions illustrated in FIG. 4 by executing the computer programs stored in the memory 13-1 and the storage unit 14-1, for example. Specifically, the processor 12-1 includes an image acquisition unit 1001, a connection control unit 1002, a processing result acquisition unit 1003, and a display control unit 1004 serving as functional units.

The image acquisition unit 1001 acquires image data from the cameras 50. The image acquisition unit 1001 outputs the acquired image data to the connection control unit 1002. The image acquisition unit 1001 also outputs the acquired image data to the display control unit 1004.

The connection control unit 1002 is an interface for outputting data from the platform 10-1 to the platforms 10-2 to 10-7.

The processing result acquisition unit 1003 acquires a processing result of AI processing. The processing result acquisition unit 1003 outputs the acquired processing result to the display control unit 1004.

The display control unit 1004 displays image data acquired by the image acquisition unit 1001 on the monitor 21, based on the processing result of the AI processing acquired by the processing result acquisition unit 1003. The display control unit 1004, for example, simultaneously displays the image data taken by the respective cameras 50 on the monitor 21.

The platforms 10-2 to 10-7 are described next. As illustrated in FIG. 4, the platforms 10-2 to 10-7 cooperate to implement an AI processor 100. The AI processor 100 performs AI processing, such as recognition of a person using a deep learning technology, on image data acquired from the cameras 50. More specifically, the AI processor 100 performs AI processing, such as person identification, person association, and person classification in a distributed manner.

More specifically, the processors 12-2 to 12-4 of the platforms 10-2 to 10-4 implement a person identification processing unit 101 that performs person identification by executing the computer programs stored in the memories 13-2 to 13-4 and the storage units 14-2 to 14-4. The processors 12-5 and 12-6 of the platforms 10-5 and 10-6 implement a person association processing unit 102 that performs person association by executing the computer programs stored in the memories 13-5 and 13-6 and the storage units 14-5 and 14-6. The processor 12-7 of the platform 10-7 implements a person classification processing unit 103 that performs person classification by executing the computer programs stored in the memory 13-7 and the storage unit 14-7.

The person identification performed by the person identification processing unit 101 is described first.

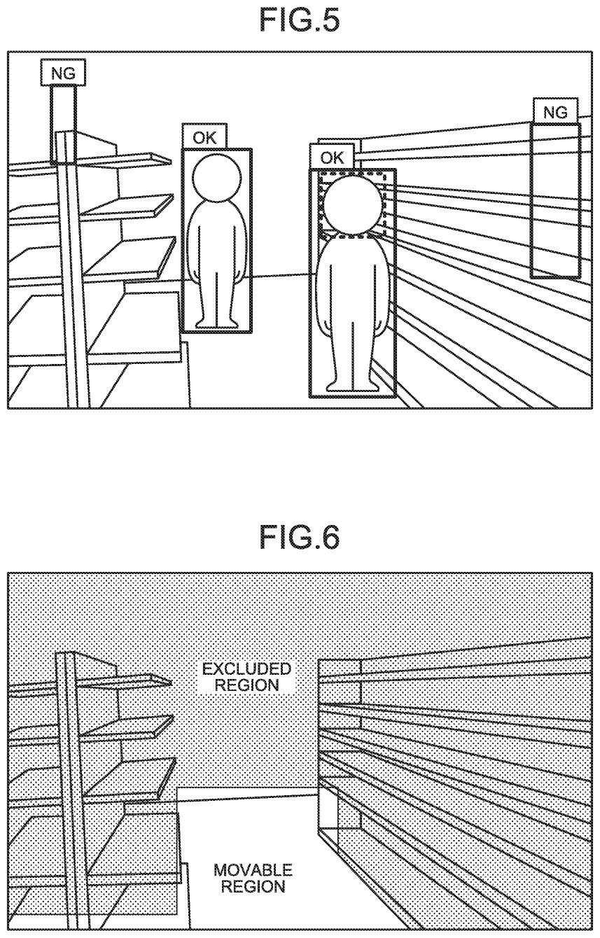

FIG. 5 is a diagram illustrating an example of a result of detecting persons from image data taken by the camera 50. As illustrated in FIG. 5, the distributed computer 1 may possibly erroneously detect part of shelves as a person. To address this, there has been a demand for a technology for preventing erroneous detection of a person.

The persons are standing on the top surface of a floor. It is assumed that no person is present in the region provided with the shelves or the like on which no person can stand. The person identification processing unit 101 excludes the region with no person from the region on which detection is to be performed, thereby reducing erroneous detection of a person.

FIG. 6 is a diagram illustrating an example of the image data on which an excluded region is set. As illustrated in FIG. 6, a region in which persons can move is set as a movable region and a region in which persons cannot move, which is other than the movable region, is set as an excluded region. The movable region is a region in which persons can move and is the region of the floor on the image data, for example. The excluded region is a region in which persons cannot move and is the region other than the floor on the image data, for example. In detecting a person, the accuracy of detecting the person can be improved by adding the condition that the person is standing on the floor, that is, the foot is in contact with the floor.

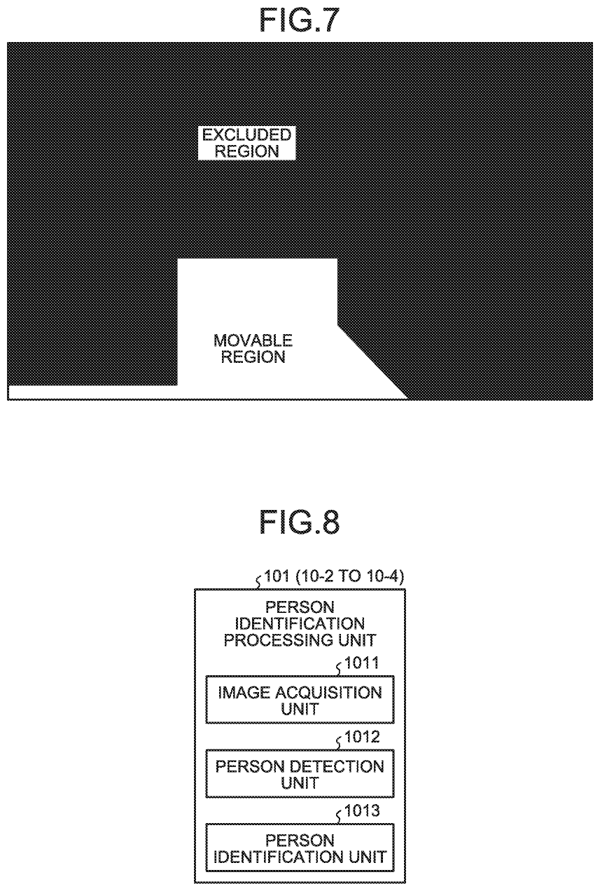

The person identification processing unit 101 applies filter information defining the excluded region and the movable region to image data obtained by imaging the same place for a plurality of times. FIG. 7 is a diagram illustrating an example of the filter information. FIG. 7 illustrates the excluded region and the movable region on the image illustrated in FIGS. 5 and 6. In FIG. 7, the black region indicates the excluded region, and the white region indicates the movable region. The filter information is image information in a bitmap format, for example.

The following describes a functional configuration of the person identification processing unit 101. FIG. 8 is a functional block diagram illustrating an example of the functional configuration of the person identification processing unit 101. The processors 12-2 to 12-4 of the platforms 10-2 to 10-4 are computers that execute the computer programs stored in the memories 13-2 to 13-4 and the storage units 14-2 to 14-4, thereby implementing the functions illustrated in FIG. 8. Specifically, the processors 12-2 to 12-4 include an image acquisition unit 1011, a person detection unit 1012, and a person identification unit 1013 serving as functional units.

The image acquisition unit 1011 is an example of an acquirer. The image acquisition unit 1011 acquires image data. The image acquisition unit 1011, for example, acquires image data taken by the camera 50 via the platform 10-1.

The person detection unit 1012 is an example of a detector. The person detection unit 1012 detects a person candidate serving as a candidate of a person from the image data. The person detection unit 1012 detects a person from the image data by pattern recognition, for example.

The person identification unit 1013 is an example of an identifier. The person identification unit 1013 identifies the person candidate detected by the person detection unit 1012 as a person when the person candidate is present on the movable region corresponding to a region in which persons can move, on the image data, based on the filter information indicating the movable region. The person identification unit 1013, for example, identifies the person candidate detected by the person detection unit 1012 as a person when the foot of the person candidate is present on the movable region. The person identification unit 1013 may identify the person candidate as a person when the head or the face is detected from the region of the person candidate with the foot placed on the movable region. The region of the person candidate is a region of the person candidate detected by the person detection unit 1012 on the image data.

Referring back to FIG. 4, the following describes person association performed by the person association processing unit 102.

As illustrated in FIG. 4, the processors 12-5 and 12-6 of the platforms 10-5 and 10-6 execute the computer programs stored in the memories 13-5 and 13-6 and the storage units 14-5 and 14-6, thereby implementing the person association processing unit 102.

The person association processing unit 102 associates the coordinates of an identified person in time-series order. More specifically, if the person identification processing unit 101 identifies the person candidate as a person, the person association processing unit 102 records the coordinates on the image data of the person identified by the person identification processing unit 101 in time-series order. As a result, the person association processing unit 102 records a locus of movement of the person identified by the person identification processing unit 101. In other words, the person association processing unit 102 enables tracking the person identified by the person identification processing unit 101.

The following describes person classification performed by the person classification processing unit 103.

As illustrated in FIG. 4, the processor 12-7 of the platform 10-7 executes the computer programs stored in the memory 13-7 and the storage unit 14-7, thereby implementing the person classification processing unit 103.

The person classification processing unit 103 classifies a person the coordinates of which are associated in time-series order. More specifically, the person classification processing unit 103 classifies the person made trackable by the person association processing unit 102. The person classification processing unit 103, for example, performs classification by the attributes, such as the sex and the age of the person. Furthermore, the person classification processing unit 103 performs classification according to whether the person is a suspicious person based on the behavior of the person, for example.

The following describes generation of the filter information.

The present embodiment describes a case where the platform 10-8 generates the filter information. The filter information may be generated by the platforms 10-1 to 10-7 other than the platform 10-8 or generated by an information processing device not illustrated in FIG. 1 and then acquired.

To generate the filter information, it is necessary to define a region in which persons can move. In other words, it is necessary to define a floor. To define a floor, a method of defining the excluded region by a formula may be employed, for example. A plurality of cameras 50, however, are provided and are placed at a plurality of positions. As a result, it is difficult to set the excluded region on each of a number of pieces of image data. Consequently, there has been a demand for a technology for facilitating setting of the excluded region. The platform 10-8 generates the filter information based on the loci of movement of a number of persons.

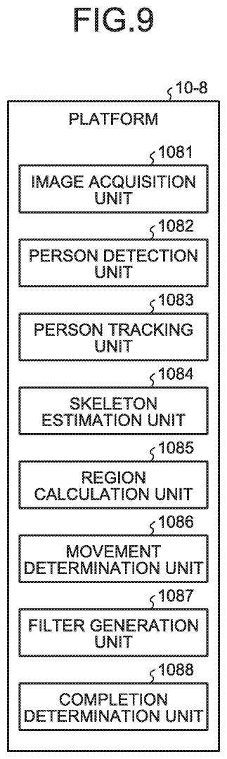

FIG. 9 is a functional block diagram illustrating an example of the functional configuration of the platform 10-8. The processor 12-8 of the platform 10-8 is a computer that implements the functions illustrated in FIG. 9 by executing the computer programs stored in the memory 13-8 and the storage unit 14-8. Specifically, the processor 12-8 includes an image acquisition unit 1081, a person detection unit 1082, a person tracking unit 1083, a skeleton estimation unit 1084, a region calculation unit 1085, a movement determination unit 1086, a filter generation unit 1087, and a completion determination unit 1088 serving as functional units.

The image acquisition unit 1081 is an example of an acquirer. The image acquisition unit 1081 acquires image data obtained by imaging the same place for a plurality of times. More specifically, the image acquisition unit 1081 acquires image data obtained by imaging the same place by the camera 50 for a plurality of times.

The person detection unit 1082 is an example of a detector. The person detection unit 1082 detects a person from image data. More specifically, the person detection unit 1082 detects a person candidate serving as a candidate of a person from the image data taken by the camera 50. The person detection unit 1082 detects the person candidate from the image data by pattern recognition, for example. If the person detection unit 1082 detects a person candidate, it sets a person region including the person candidate on the image data. As illustrated in FIG. 5, for example, the person detection unit 1082 sets rectangular person regions surrounding the respective persons on the image data. Furthermore, the person detection unit 1082 sets a head region indicating a region of the head of the person and a face region indicating a region of the face in the person region on the image data.

The person tracking unit 1083 records the coordinates at each time of the person candidate detected by the person detection unit 1082 for each of the person candidates. As a result, the person tracking unit 1083 tracks movement of the person detected from the image data. More specifically, the person tracking unit 1083 determines whether a person code for identifying a person is allocated to the person candidate detected by the person detection unit 1082. If no person code is allocated, the person tracking unit 1083 allocates a person code to the person candidate. The person tracking unit 1083 records the coordinates at which the person detection unit 1082 detects the person candidate in time-series order. By contrast, if the person code is allocated, the person tracking unit 1083 records the coordinates at which the person detection unit 1082 detects the person candidate in time-series order in a manner associated with the person code.

The skeleton estimation unit 1084 estimates the skeleton of a person candidate serving as a candidate of a person included in image data. More specifically, the skeleton estimation unit 1084 estimates the skeleton of the person candidate detected by the person detection unit 1082. If the skeleton estimation unit 1084 estimates the skeleton of the person candidate, it acquires the coordinates of each part on the image data. The skeleton estimation unit 1084, for example, acquires the coordinates of the ankle of the person candidate.

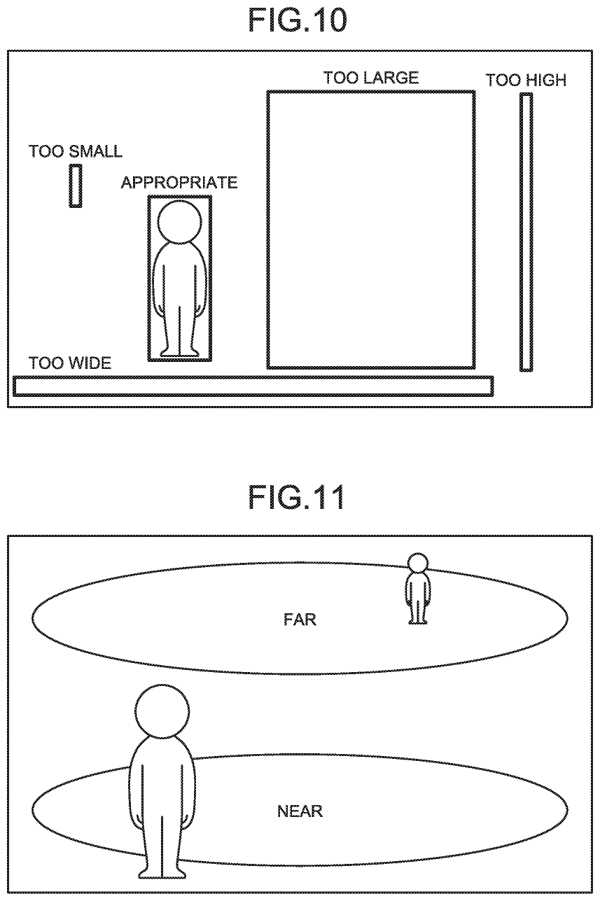

The region calculation unit 1085 is an example of a calculator. The region calculation unit 1085 calculates the aspect ratio and the area of a region on image data of a person candidate serving as a candidate of a person included in image data. More specifically, the region calculation unit 1085 calculates the aspect ratio and the area of the person region of the person candidate detected by the person detection unit 1082. FIG. 10 is a diagram illustrating an example of a result of detecting the person candidate by the person detection unit 1082. FIG. 11 is a diagram illustrating an example of a detection result depending on the position for imaging the person candidate by the person detection unit 1082. As illustrated in FIG. 10, if the person detection unit 1082 detects a person candidate, the person region has an appropriate aspect ratio. If the person detection unit 1082 erroneously detects an object other than a person as a person, the person region has a too small, too wide, too large, or too high shape, for example.

As illustrated in FIG. 11, the size of the person region changes depending on whether the person candidate is close to or away from the camera 50. The region calculation unit 1085 calculates the aspect ratio and the area of the person region set on the image data. If the calculated area of the person region falls within a preset range, and the aspect ratio falls within a preset range, the region calculation unit 1085 determines the corresponding person candidate to be a person.

The movement determination unit 1086 determines whether a person candidate serving as a candidate of a person included in image data has moved, based on a change in the area of the region of the person candidate on the image data. More specifically, the movement determination unit 1086 detects movement of a person based on a change in the size of the person region of the person candidate detected by the person detection unit 1082. A person moves. By contrast, if the result of detection by the person detection unit 1082 is an object other than a person, the object does not move. The movement determination unit 1086 determines whether the detection result is a person based on whether movement of the person candidate is detected. If the size of the person region changes by a threshold of 20% or more, for example, the movement determination unit 1086 determines that the person is moving.

If the person candidate moves close to or away from the camera 50, for example, the size of the person region changes as illustrated in FIG. 11. If the person candidate enters into or leaves an imaging region of the camera 50, the size of the person region changes at the boundary of the imaging region. Specifically, if a person enters into the imaging region, the body is partially included in the imaging region just after the entering, but the part of the body included in the imaging region increases as time elapses. By contrast, if a person leaves the imaging region, substantially the whole body is included in the imaging region just after the leaving, but the part of the body included in the imaging region decreases as time elapses. As described above, the size of the person region changes when the person candidate enters into or leaves the imaging region of the camera 50. The movement determination unit 1086 detects movement of a person based on whether the size of the person region changes by the threshold or more.

The filter generation unit 1087 is an example of a generator. The filter generation unit 1087 generates the filter information indicating the movable region in which persons can move, on image data, based on loci obtained by connecting the coordinates of the respective person candidates recorded by the person tracking unit 1083 in time-series order. More specifically, the filter generation unit 1087 extracts the person code of the person determined to be a person by the skeleton estimation unit 1084, the region calculation unit 1085, and the movement determination unit 1086 out of the person candidates detected by the person detection unit 1082. The filter generation unit 1087 acquires the coordinates at each time of the person corresponding to the extracted person code recoded by the person tracking unit 1083.

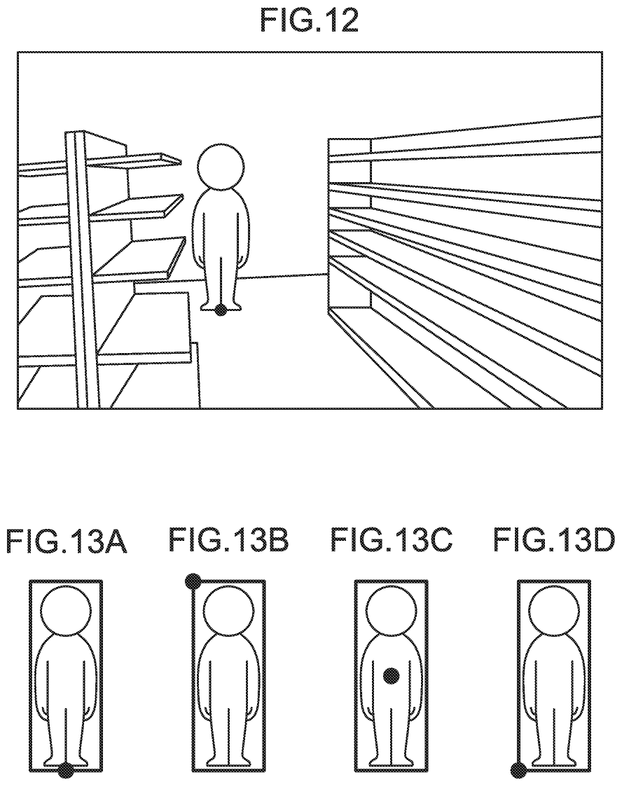

The filter generation unit 1087 plots a coordinate point indicating the acquired coordinates at each time. FIG. 12 is a diagram illustrating an example of plotting the coordinate point. As illustrated in FIG. 12, the filter generation unit 1087 plots the coordinate point at the center of the bottom side of the person region of the person. The position of plotting is not limited to the center of the bottom side of the person region of the person, and the filter generation unit 1087 may plot the coordinate point at other positions.

FIGS. 13A to 13D are diagrams of an example of a plot position of the coordinate point. FIG. 13A illustrates a state where the coordinate point is plotted at the center of the bottom side of the person region. FIG. 13B illustrates a state where the coordinate point is plotted at the left end of the upper side of the person region. FIG. 13C illustrates a state where the coordinate point is plotted at the center of the person region in the width and height directions. FIG. 13D illustrates a state where the coordinate point is plotted at the left end of the bottom side of the person region. As illustrated in FIGS. 13A to 13D, the coordinate point is not necessarily plotted at the center of the bottom side of the person region of the person and may be plotted at any position in the person region.

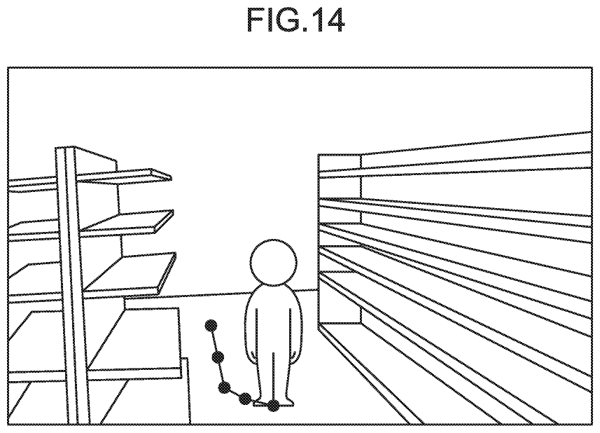

The filter generation unit 1087 plots the coordinate point for each of the coordinates at each time. The filter generation unit 1087 connects the plotted coordinate points in time-series order of acquiring the coordinates serving as the basis of the respective coordinate points. FIG. 14 is a diagram illustrating an example of a state where the coordinate points are connected in time-series order. As illustrated in FIG. 14, the filter generation unit 1087 connects the coordinate points of the same person in time-series order, thereby generating a locus along which the person has moved. While a locus of movement of one person is represented by a line, loci of movement of a plurality of persons produce a plane. The filter generation unit 1087 generates the filter information indicating the movable region corresponding to a region in which persons can move, based on the loci of movement of a plurality of persons.

The movable region indicates a region in which persons can move. The filter generation unit 1087 should not generate the filter information based on a locus of movement of an object other than a person. The filter generation unit 1087 generates the filter information based on the locus of the person corresponding to the person candidate the skeleton of which can be estimated by the skeleton estimation unit 1084. Alternatively, the filter generation unit 1087 generates the filter information based on the locus of the person corresponding to the person candidate having the aspect ratio and the area calculated by the region calculation unit 1085 falling within the set range. Still alternatively, the filter generation unit 1087 generates the filter information based on the locus of the person corresponding to the person candidate determined to move by the movement determination unit 1086.

The filter generation unit 1087 may generate the filter information based on the locus of the person determined to be a person by all of the skeleton estimation unit 1084, the region calculation unit 1085, and the movement determination unit 1086. Alternatively, the filter generation unit 1087 may generate the filter information based on the locus of the person determined to be a person by a majority decision in the determination results of these functional units. Still alternatively, the filter generation unit 1087 may generate the filter information based on the locus of the person determined to be a person by any one of these functional units.

As described with reference to FIG. 11, the person region becomes larger when the person is closer to the camera 50 and becomes smaller when the person is farther away from the camera 50. The locus indicates the positions where the person has passed. If the thickness of the locus at a position away from the camera 50 is equal to that of the locus at a position close to the camera 50, the person is considered to pass a position where the person has not actually passed. If the thickness of the locus at a position close to the camera 50 is equal to that of the locus at a position away from the camera 50, the person is considered not to pass a position where the person has actually passed.

To address this, the filter generation unit 1087 changes the thickness of the locus depending on the position of the person on the image data. As the person moves away from the camera 50, the position of the person moves upward on the image data. The filter generation unit 1087 changes the thickness of the locus based on the coordinates of the coordinate point in the X-axis direction on the image data. The filter generation unit 1087, for example, changes the thickness to 10% of the width of the person region.

The filter generation unit 1087 generates the filter information by filling the gap between the loci. It takes, however, a long time to generate the whole movable region by the loci. The filter generation unit 1087 can reduce the generation time by considering the gaps between the loci as passed positions and filling the gaps. If the filter generation unit 1087 fills all the gaps, however, it fills the gaps more than necessary.

Let us assume a case where an article is placed at the center of an aisle, for example. In this case, a person passes through the aisle while avoiding the article, whereby loci are generated on both sides of the article. To fill all the gaps, the position at which the article is placed is also a target to be filled. The position at which the article is placed, however, should not be filled with the locus because no person passes therethrough. If the distance of the gap between the loci is equal to or smaller than a threshold, the filter generation unit 1087 fills the gap. The threshold may be a desired value, a value calculated by a formula, or other values. The threshold, for example, may be a value determined based on the coordinates in the X-axis direction, a value determined based on the width of the person region, or other values.

The completion determination unit 1088 determines whether generation of the filter information is completed. The criterion for determining completion of generation of the filter information may be a desired condition. The completion determination unit 1088, for example, may determine that generation is completed if the movable region does not increase when a set number or more of persons have passed. Alternatively, the completion determination unit 1088 may determine that generation is completed if the movable region does not increase when a set time has elapsed. Still alternatively, the completion determination unit 1088 may determine that generation is completed if the video taken by the camera 50 ends.

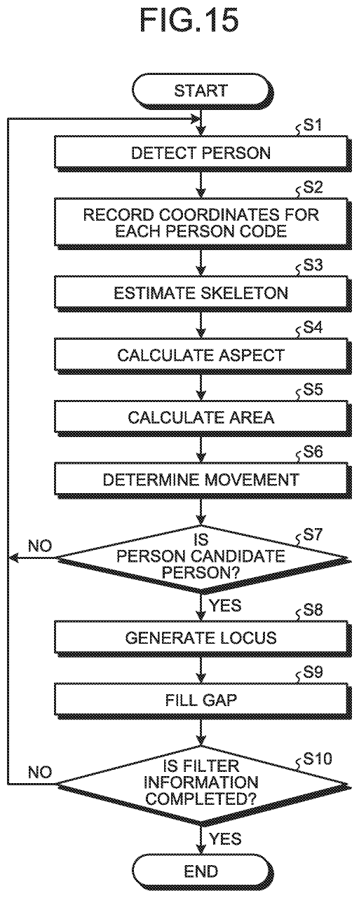

The following describes filter generation performed by the platform 10-8. FIG. 15 is a flowchart illustrating an example of the filter generation according to the present embodiment. The filter generation is processing of generating the filter information.

The person detection unit 1082 performs person detection of detecting a person candidate from image data acquired from the camera 50 (Step S1).

The person tracking unit 1083 records the coordinates of the person candidate on the image data in time-series order for each person code (Step S2).

The skeleton estimation unit 1084 estimates the skeleton of the person candidate detected by the person detection unit 1082 (Step S3).

The region calculation unit 1085 calculates the aspect ratio of the person region of the person candidate detected by the person detection unit 1082 (Step S4).

The region calculation unit 1085 calculates the area of the person region of the person candidate detected by the person detection unit 1082 (Step S5).

The movement determination unit 1086 determines whether the person candidate detected by the person detection unit 1082 has moved (Step S6).

The filter generation unit 1087 determines whether the person candidate detected by the person detection unit 1082 is a person, based on the determination results of the skeleton estimation unit 1084, the region calculation unit 1085, and the movement determination unit 1086 (Step S7). If the filter generation unit 1087 determines that the person candidate is not a person (No at Step S7), the platform 10-8 performs processing at Step S1 again.

If the person candidate is a person (Yes at Step S7), the filter generation unit 1087 generates a locus of movement of the person (Step S8).

The filter generation unit 1087 fills the gap between the loci the distance of which is equal to or smaller than a threshold (Step S9). In other words, the filter generation unit 1087 considers the gap as the movable region.

The completion determination unit 1088 determines whether the criterion for determining completion of the filter information is satisfied (Step S10). If the criterion for determining completion of the filter information is not satisfied (No at Step S10), the platform 10-8 performs the processing at Step S1 again.

If the criterion for determining completion of the filter information is satisfied (Yes at Step S10), the platform 10-8 ends the filter generation.

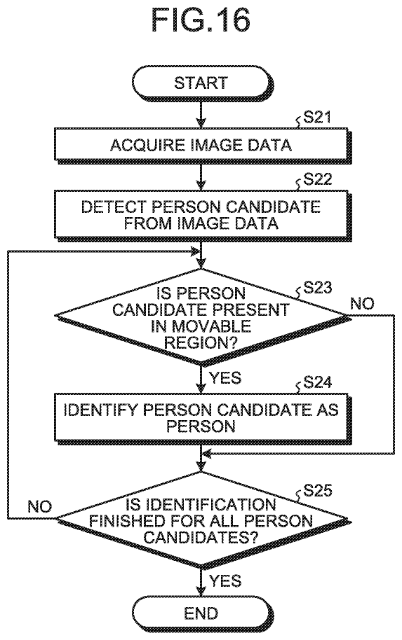

The following describes person identification performed by the person identification processing unit 101 of the platforms 10-2 to 10-4. To perform person identification, the present embodiment uses the filter information generated by the filter generation illustrated in FIG. 15. The use of the filter information reduces the processing load and enables accurate identification of a person. FIG. 16 is a flowchart illustrating an example of person identification by the person identification processing unit 101 according to the present embodiment.

The image acquisition unit 1011 acquires image data taken by the camera 50 via the platform 10-1 (Step S21).

The person detection unit 1012 detects a display region having a possibility of being a person on the image data as a person candidate (Step S22). To detect a person candidate, the person detection unit 1012 may use pattern recognition or other methods, for example.

The person identification unit 1013 determines whether the person candidate detected by the person detection unit 1012 is present in the movable region indicated by the filter information generated by the filter generation unit 1087 (Step S23). If it is determined that the person candidate is not present (No at Step S23), the person identification unit 1013 determines that the person candidate is not a person, and the processing proceeds to Step S25.

By contrast, if the person identification unit 1013 determines that the person candidate detected by the person detection unit 1012 is present in the movable region indicated by the filter information generated by the filter generation unit 1087 (Yes at Step S23), the person identification unit 1013 identifies the person candidate as a person (Step S24). The criterion for determining that the person candidate is present in the movable region may be whether the lower end of (the display region detected as) the person candidate or a predetermined region from the lower end of (the display region detected as) the person candidate is included in the movable region, for example. The determination criterion is not limited thereto and may be any determination criterion that can assume that a person is present in the movable region.

The person identification processing unit 101 determines whether the identification is finished for all the person candidates included in the image data (Step S25). If the person identification processing unit 101 determines that the identification is not finished for all the person candidates (No at Step S25), the person identification processing unit 101 performs the processing at Step S23 again.

If the person identification processing unit 101 determines that the identification is finished for all the person candidates (Yes at Step S25), the person identification processing unit 101 ends the processing.

As indicated by the processing illustrated in FIG. 16, the person identification unit 1013 identifies the person candidate detected by the person detection unit 1012 as a person when the person candidate is present on the movable region, based on the filter information. In other words, if a person candidate is detected in a region with no person, the person identification unit 1013 determines that the person candidate is not a person. Consequently, the platforms 10-2 to 10-4 according to the present embodiment can reduce erroneous detection of a person.

As described above, the image acquisition unit 1081 of the platform 10-8 according to the present embodiment acquires image data obtained by imaging the same place for a plurality of times. The person tracking unit 1083 records the coordinates at each time of a person candidate detected by the person detection unit 1082 for each of the person candidates. The filter generation unit 1087 identifies a person from the person candidate detected from the image data by the person detection unit 1082, based on the determination results of the skeleton estimation unit 1084, the region calculation unit 1085, and the movement determination unit 1086. By combining the loci each obtained by connecting the respective coordinates of a number of persons in time-series order, a plane is defined indicating a region in which persons can move. The filter generation unit 1087 generates the filter information indicating the movable region, based on the loci obtained by connecting the coordinates of each of the persons recorded by the person tracking unit 1083 in time-series order. Consequently, the platform 10-8 according to the present embodiment can generate the filter information.

The embodiment describes PCIe as an example of a bus (e.g., an expansion bus) or an I/O interface for the units, the bus or the I/O interface is not limited to PCIe. The bus or the I/O interface for the units simply needs to be provided by a technology that can transfer data between a device (peripheral controller) and a processor by a data transfer bus. The data transfer bus may be a general-purpose bus that can transfer data at high speed in local environment (e.g., one system or one device) provided to one housing or the like. The I/O interface may be any one of a parallel interface and a serial interface.

To perform serial transfer, the I/O interface may have a configuration that can establish point-to-point connection and transfer data in a packet-based manner. To perform serial transfer, the I/O interface may include a plurality of lanes. The layer structure of the I/O interface may include a transaction layer that generates packets and performs decoding, a data link layer that performs error detection and other processing, and a physical layer that converts between serial and parallel. The I/O interface may include a root complex that is in the highest layer and including one or a plurality of ports, an end point serving as an I/O device, a switch for increasing the number of ports, and a bridge that converts the protocol, for example. The I/O interface may multiplex data to be transmitted and clock signals by a multiplexer and transmit the multiplexed data and clock signals. In this case, the recipient may separate the data from the clock signals by a demultiplexer.

The following notes are disclosed according to the embodiment above.

Note 1. An information processing device including a hardware processor configured to:

acquire image data;

detect a person candidate serving as a candidate of a person from the image data; and

configured to identify the detected person candidate as the person when the person candidate is present on a movable region corresponding to a region in which the person is able to move, based on filter information indicating the movable region on the image data.

Note 2. The information processing device according to Note 1, wherein the hardware processor is configured to:

generate the filter information indicating the movable region in which the person is determined to be able to move, on the image data, based on coordinates indicating a predetermined position near a bottom side of the place in a gravity direction in a person region representing the person detected from the acquired image data;

acquire the image data obtained by imaging a predetermined place; and

identify the detected person candidate as the person when the person candidate is present on the movable region, on the image data, based on the generated filter information.

Note 3. The information processing device according to Note 1, wherein the hardware processor is configured to identify the detected person candidate as the person when a foot of the person candidate is present on the movable region.

Note 4. The information processing device according to Note 3, wherein the hardware processor is configured to identify the person candidate with the foot placed on the movable region as the person when a head or a face is detected from a region of the person candidate.

Note 5. The information processing device according to Note 1, wherein the movable region is a region of a floor on the image data.

Note 6. A computer program product including programmed instructions embodied in and stored on a non-transitory computer readable medium, the instructions causing a computer included in an information processing device to:

acquire image data;

detect a person candidate serving as a candidate of a person from the image data; and

identify the detected person candidate as the person when the person candidate is present on a movable region corresponding to a region in which the person is able to move, based on filter information indicating the movable region on the image data.

The information processing device and the computer program product according to the present invention can reduce erroneous detection of a person.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing device comprising:
a hardware processor that:
acquires image data obtained by imaging a same place for a plurality of times;
detects a person from the image data; and
generates filter information indicating a movable region in which the person is able to move, based on coordinates indicating a predetermined position, in a person region representing the person detected at each time.

2. The information processing device according to claim 1, wherein the hardware processor generates the filter information indicating the movable region in which the person is able to move, based on the coordinates indicating the predetermined position near a bottom side of the place in a gravity direction in the person region.

3. The information processing device according to claim 1, wherein the hardware processor identifies a person candidate that is a candidate of the person detected from the image data as the person when the person candidate is present on the movable region, based on the filter information.

4. The information processing device according to claim 3, wherein the hardware processor identifies the detected person candidate as the person when a foot of the person candidate is present on the movable region.

5. The information processing device according to claim 4, wherein the hardware processor identifies the person candidate as the person when a head or a face is detected from a region of the person candidate with the foot placed on the movable region.

6. The information processing device according to claim 3, wherein the hardware processor generates the filter information by filling a gap between a plurality of loci obtained by connecting coordinates of a plurality of the detected persons in time-series order.

7. The information processing device according to claim 6, wherein the hardware processor changes a thickness of a locus depending on a position of the person on the image data.

8. The information processing device according to claim 6, wherein the hardware processor:
estimates a skeleton of the person candidate serving as a candidate of the person included in the image data; and
generates the filter information based on a locus of the person corresponding to the person candidate the skeleton of which is able to be estimated.

9. The information processing device according to claim 6, wherein the hardware processor:
calculates an aspect ratio and an area of a region of a person candidate on the image data, the person candidate serving as a candidate of the person included in the image data; and
generates the filter information based on a locus of the person corresponding to the person candidate having the calculated aspect ratio and area falling within a set range.

10. The information processing device according to claim 6, wherein the hardware processor:
determines whether the person candidate serving as a candidate of the person included in the image data has moved, based on a change in the area of the region of the person candidate on the image data; and
generates the filter information based on a locus of the person corresponding to the person candidate determined to have moved.

11. The information processing device according to claim 1, wherein the movable region is a region of a floor on the image data.

12. A computer program product including programmed instructions embodied in and stored on a non-transitory computer readable medium, the instructions cause a computer executing the instructions to:
acquire image data obtained by imaging a same place for a plurality of times;
detect a person from the image data; and
generate filter information indicating a movable region in which the person is able to move, based on coordinates indicating a predetermined position, in a person region representing the person detected at each time.

13. An information processing device comprising:
a hardware processor that:
acquires image data;
detects a person candidate serving as a candidate of a person from the image data; and
identifies the detected person candidate as the person when the person candidate is present on a movable region corresponding to a region in which the person is able to move, based on filter information indicating the movable region on the image data.

14. The information processing device according to claim 13, wherein the hardware processor:
acquires the image data obtained by imaging a predetermined place;
generates the filter information indicating the movable region in which the person is determined to be able to move, on the image data, based on coordinates indicating a predetermined position near a bottom side of the place in a gravity direction in a person region representing the person detected from the acquired image data; and
identifies the detected person candidate as the person when the person candidate is present on the movable region, on the image data, based on the generated filter information.

15. The information processing device according to claim 13, wherein the hardware processor identifies the detected person candidate as the person when a foot of the person candidate is present on the movable region.

16. The information processing device according to claim 15, wherein the hardware processor identifies the person candidate with the foot placed on the movable region as the person when a head or a face is detected from a region of the person candidate.

17. The information processing device according to claim 13, wherein the movable region is a region of a floor on the image data.
